(19) United States
(12) Patent Application Publication
(10) Pub. No.: US 2024/0040255 A1
(43) Pub. Date: Feb. 1, 2024

(54) VIDEO SHOOTING METHOD, APPARATUS AND ELECTRONIC DEVICE TECHNICAL FIELD

(71) Applicant: Black Sesame Technologies (Chengdu) Co., Ltd., Chongqing (CN)

(72) Inventor: Zhenwei Yuan, Wuhan (CN)

(21) Appl. No.: 18/228,638

(22) Filed: Jul. 31, 2023

(30) Foreign Application Priority Data
Jul. 29, 2022 (CN) 202210910036.8

(51) Int. Cl. H04N 23/68

(52) U.S. Cl. CPC H04N 23/687; H04N 23/6812

(57) ABSTRACT

A video shooting method and apparatus, and an electronic device are provided. The video shooting method includes: acquiring a motion state of an imaging device during shooting of a video; when the imaging device is in a first motion state, performing anti-shake processing on the video in a first anti-shake manner that matches the first motion state; and when the imaging device is in a second motion state, performing anti-shake processing on the video in a second anti-shake manner that matches the second motion state, wherein a shaking amplitude in the first motion state is different from a shaking amplitude in the second motion state. This embodiment of the present application implements integration of multiple anti-shake technologies. By using respective advantages of different anti-shake technologies, video anti-shake requirements of various shake scenarios can be adapted and have broad applicability.

### FIELD OF THE INVENTION

The present application relates to the field of video shooting and processing technologies, and in particular, to a video shooting method, apparatus, and an electronic device.

### BACKGROUND OF THE INVENTION

In daily life, an electronic device such as a hand-held device, a wearable device, or a vehicle-mounted device inevitably introduces a shake when shooting a video, which causes poor quality of a captured video picture, and even affects subsequent analysis and identification. To reduce or eliminate the impact of electronic device shake on the captured video, many video anti-shake technologies have been developed. Currently, mainstream video anti-shake technologies may be classified into optical anti-shake, electronic anti-shake, digital anti-shake, and the like. However, a single anti-shake technology cannot automatically adapt to a requirement for image stabilization in shake scenarios of different degrees.

### SUMMARY OF THE INVENTION

Embodiments of the present application provide a video shooting method and apparatus, and an electronic device. The following describes aspects of the embodiments of the present application.

According to a first aspect, a video shooting method is provided, including: acquiring a motion state of an imaging device during shooting of a video; when the imaging device is in a first motion state, performing anti-shake processing on the video in a first anti-shake manner that matches the first motion state; and when the imaging device is in a second motion state, performing anti-shake processing on the video in a second anti-shake manner that matches the second motion state, wherein a shaking amplitude in the first motion state is different from a shaking amplitude in the second motion state.

According to a second aspect, a video shooting apparatus is provided, including: an imaging device, configured to shoot a video; and a processing module, connected to the imaging device, and configured to perform the following operations: acquiring a motion state of the imaging device during shooting of the video; when the imaging device is in a first motion state, performing anti-shake processing on the video in a first anti-shake manner that matches the first motion state; and when the imaging device is in a second motion state, performing anti-shake processing on the video in a second anti-shake manner that matches the second motion state, wherein a shaking amplitude in the first motion state is different from a shaking amplitude in the second motion state.

According to a third aspect, an electronic device is provided, including: a memory, configured to store a computer program; and a processor, connected to the memory and configured to implement the method according to the first aspect when executing the computer program.

According to a fourth aspect, a computer readable storage medium is provided, on which a computer program is stored, wherein when executed by a processor, the computer program implements the method according to the first aspect.

In this embodiment of the present application, a motion state of an imaging device during shooting of a video is obtained, and anti-shake processing is performed on the video by using an anti-shake technology that matches the motion state based on the motion state of the imaging device. In this embodiment of the present application, by using advantages of different anti-shake technologies, integration of different anti-shake technologies is implemented, which can adapt to video anti-shake requirements of various shake scenarios, and has broad applicability, which helps improve image stabilization effect.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference similar features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a schematic flowchart of a video shooting method according to an embodiment of the present application.

FIG. 2 is a schematic flowchart of a possible implementation manner of the method shown in FIG. 1.

FIG. 3 is a schematic flowchart of a possible implementation manner of the S230-S240 step of the method shown in FIG. 2.

FIG. 4 is a schematic structural diagram of a video shooting apparatus according to an embodiment of the present application.

FIG. 5 is a schematic structural diagram of an electronic device according to an embodiment of the present application.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

Regarding applicability of 35 U.S.C. § 112, 916, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification comprises references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

The following clearly and completely describes the technical solutions in the embodiments of the present application with reference to the accompanying drawings in the embodiments of the present application. Apparently, the described embodiments are only a part rather than all of the embodiments of the present application.

In daily life, an electronic device such as a hand-held device, a wearable device, or a vehicle-mounted device inevitably introduces a shake when shooting a video, which causes poor quality of a captured video picture, and even affects subsequent analysis and identification. To reduce or eliminate the impact of electronic device shake on the captured video, many video anti-shake technologies have been developed. Currently, mainstream video anti-shake technologies mainly include optical anti-shake, electronic anti-shake, digital anti-shake, and the like.

The optical anti-shake is an abbreviation of an optical image stabilization (optical image stabilization, OIS), and may be compensated for a shake optical path by using a moveable component built in an electronic device, such as a micro gimbal, so as to reduce blur caused by shake in a captured picture. A lens supporting the OIS may be understood as a camera module of a built-in gimbal. To obtain an optical anti-shake function of the OIS, a micro motor that can move in multiple directions needs to be installed inside the lens. When shooting a video, the system may convert real-time shake information monitored by a gyroscope and an acceleration sensor into an electrical signal. Based on these data, the control driver of OIS predicts an image offset caused by an inclination, and then feeds back a result to the micro motor in the lens, so that the micro motor pushes the sensor to move with a displacement that predicts a same image offset but opposite direction, thereby canceling the image offset caused by the shake.

In the OIS technology, in a hardware manner, the lens is in the process of shooting without being interfered by small shake, and an effect is stable. However, hardware support of a device is required, and therefore costs are relatively high.

The electronic anti-shake is an abbreviation for an electric image stabilization (electric image stabilization, EIS), and is used to record a motion of an imaging device by using a sensor of an inertial measurement unit (inertial measurement unit, IMU), estimate a motion of a video frame, and filter to smooth, so that a large shake in a shooting process is less severe.

The digital anti-shake is an abbreviation of digital image stabilization (digital image stabilization, DIS). An operation may be performed on the acquired image sequence by using only digital image processing technology, and anti-shake process is implemented in an image feature matching, motion information extraction, and image conversion manner. The DIS can better reflect a most real motion of a video frame, but image feature matching is limited to image content. A relatively good processing result may be obtained for a scenario in which shooting is clear and a motion amplitude is small. If the motion is slightly more severe, the picture is blurred or cannot be matched, so it cannot work, resulting in a poor processing effect. Therefore, this technology has a disadvantage of low stability, and is mainly applicable to a large quantity of small amplitude anti-shake.

It can be learned that each anti-shake technology has its own advantages, disadvantages, and applicable scenarios. However, a shake status of an electronic device during shooting of a video is changed by moment and cannot be predicted. Therefore, it is difficult to adapt to a video image stabilization effect requirement of a shake scenario of different degrees by using any anti-shake technology alone.

Therefore, how to develop a video anti-shake solution adapted to various shake scenarios is a problem that needs to be solved.

Based on this, an embodiment of the present application provides a video shooting method. The following describes this embodiment of the present application in detail.

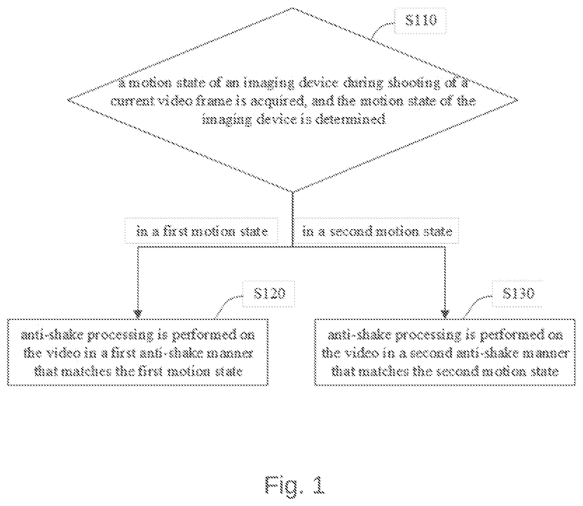

FIG. 1 is a schematic flowchart of a video shooting method according to an embodiment of the present application. The method in FIG. 1 includes step S110 to step S140. The following describes these steps in detail.

In step S110, a motion state of an imaging device during shooting of a current video frame is acquired, and the motion state of the imaging device is determined.

The imaging device may be various digital cameras, cameras, smartphone shooting apparatuses, or the like. The imaging device may typically include a lens, a gimbal, and a body. In some embodiments, the lens is disposed on the gimbal, the gimbal is disposed on the body, and the gimbal may be a micro gimbal. The gimbal is also referred to as an optical gimbal and is a supporting device for installing and fastening an imaging device such as a mobile phone, a camera, and a camera. The gimbal can be rotated freely for easy use.

In some implementations, the motion state of an imaging device body is consistent with the motion state of the lens. Movement of the imaging device body is recorded by using a gyroscope built in an inertial measurement unit, that is, movement of the lens. The gyroscope is also referred to as a Gyro-Sensor (Gyro-Sensor) and is a measurement instrument that can detect an angle (a posture), an angular velocity, or an angular acceleration of an object. For example, an EIS anti-shake solution is performed by using the Gyro-Sensor, and a posture Euler angle of a camera may be obtained by using an attitude algorithm method, that is, a motion posture of the lens is represented, and the motion state of the lens is further obtained.

In some embodiments, the imaging device may not have a gimbal, a lens is disposed on a body, and a motion state of an imaging device body is consistent with a motion state of the lens.

In some implementations, the motion state of an imaging device body is different from the motion state of the lens. If the OIS function device is installed and enabled, the lens is installed on the optical gimbal. As the imaging device moves, the gimbal compensates for the corresponding shake. Therefore, a posture angle calculated by a gyroscope is not a posture angle of the lens, and the posture angle of the lens may be obtained by compensating for an angle change of the gimbal by using the posture angle of the device. For example, data of the gyroscope is aligned with data of an OIS gimbal in a time and a direction, and the posture angle of the lens is obtained based on angle calculation, so as to determine the motion state of the lens.

In some implementations, the motion state of the lens may be determined by acquiring first motion data and second motion data of the imaging device. The first motion data is motion data collected by a sensor used in an electronic anti-shake manner, for example, data of a gyroscope and an acceleration sensor in IMU, which represents a motion state of the body. The second motion data is motion data used when the gimbal performs motion compensation on the imaging device. Based on the first motion data of the body and the second motion data compensated by the gimbal, actual motion data of the lens of the imaging device, such as a posture angle or a motion posture of the lens, may be determined, so as to obtain the motion state of the lens during shooting of video.

In some implementations, a posture angle of the lens is in a one-to-one correspondence with a posture angle of the captured video frame, or a motion state of the lens during shooting of the video may be obtained based on a change of an angular velocity of the video frame captured by the lens.

As mentioned earlier, the DIS aims to solve a more refined problem by using image content. Once the image is blurred, errors may occur, and therefore a small shake state is mainly processed. The electronic anti-shake is designed to solve a relatively large shake by using a sensor, so that a large shake in a shooting process is less severe and is applicable to a moving state of the large shake. Various anti-shake technologies have different shake applicable scenarios. Therefore, determining the motion state of the imaging device is a necessary step.

The motion state of the imaging device may be determined based on factors such as a shaking amplitude, a shaking duration, and a shaking rule. For example, a magnitude of shake may be distinguished based on the shaking amplitude, an instantaneous shake and a persistent shake may be distinguished based on the shaking duration, and a regular shake and an irregular shake may be distinguished based on the shaking rule. A specific method for determining the motion state of the imaging device is described in detail below.

If the imaging device is in a first motion state, step S120 is performed. If the imaging device is in a second motion state, step S130 is performed.

In step S120, when the image device is in the first motion state, anti-shake processing is performed on the video in a first anti-shake manner that matches the first motion state. The first motion state may be a large shake state, a regular shake state, or a unidirectional motion state.

The first anti-shake manner may be a single anti-shake technology, or the first anti-shake manner may be an anti-shake manner combined with multiple anti-shake technologies. For example, the first anti-shake manner may be an electronic anti-shake technology suitable for processing the first motion state or may be an anti-shake method combined with an optical anti-shake technology and the electronic anti-shake technology suitable for processing the first motion state. That is, this embodiment of the present application can be applied to a scenario in which the single anti-shake technology is used or can be applied to a scenario in which multiple anti-shake technologies are used together.

In step S130, when the image device is in the second motion state, anti-shake processing is performed on the video in a second anti-shake manner that matches the second motion state. Wherein a shaking amplitude in the first motion state is different from a shaking amplitude in the second motion state. The second motion state may be a small amplitude irregular shake state, and the shaking amplitude in the second motion state is less than the shaking amplitude in the first motion state. The second motion state is different from a transient shake state and is also different from a shake state in which a single backward slow move is performed.

The second anti-shake manner may be a single anti-shake technology, or the second anti-shake manner may be an anti-shake manner combined with multiple anti-shake technologies. For example, the second anti-shake manner may be a digital anti-shake technology suitable for processing the second motion state or may be an anti-shake method combined with the optical anti-shake technology and the digital anti-shake technology suitable for processing the second motion state.

In some implementations, before the electronic anti-shake manner is switched to a digital anti-shake manner, the shaking rule of the imaging device needs to be determined. If the imaging device performs an irregular shake, switching an anti-shake manner of the imaging device from the electronic anti-shake manner to the digital anti-shake manner. If the imaging device performs the regular shake, continue to perform anti-shake processing on the video in the electronic anti-shake manner.

In some implementations, before the digital anti-shake manner is switched to the electronic anti-shake manner, the shaking rule of the imaging device needs to be determined. If the imaging device performs a small irregular shake, continuing to perform anti-shake processing on the video in the digital anti-shake manner. If the imaging device performs the regular shake, switching an anti-shake manner of the imaging device from the digital anti-shake manner to the electronic anti-shake manner.

A first anti-shake technology and A second anti-shake technology are two different image stabilization manners, have different anti-shake mechanisms, and may be considered as two different motion tracks. Therefore, if no processing is performed during the switching, a video shake caused by the switching is caused.

In some implementations, if the imaging device switches from the first motion state to the second motion state, before the first anti-shake manner is switched to the second anti-shake manner, a difference between a video frame obtained based on the processing performed in the first anti-shake manner and an original video frame is gradually reduced, so as to reduce the video shake caused by switching from the first anti-shake manner to the second anti-shake manner. Similarly, if the imaging device switches from the second motion state to the first motion state, before the second anti-shake manner is switched to the first anti-shake manner, a difference between a video frame obtained based on the processing performed in the second anti-shake manner and an original video frame is gradually reduced, so as to reduce the video shake caused by switching in the anti-shake manner.

In some implementations, before the first anti-shake manner is switched to the second anti-shake manner, the difference between the video frame obtained based on the processing performed in the first anti-shake manner and the original video frame is gradually reduced. The video may include a reference frame, where the reference frame is the first video frame obtained after the first anti-shake manner is switched to the second anti-shake manner, and the reference frame is the original video frame that has not been processed in the first anti-shake manner Anti-shake processing is performed in the second anti-shake manner on the reference frame and a subsequent video frame, so as to reduce the video shake caused when the first anti-shake manner is switched to the second anti-shake manner.

In some embodiments, since the DIS and the EIS are two completely different image stabilization manners, two different motion tracks may be considered. Therefore, if no processing is performed during the switching, the video shake caused by the switching is caused. During a state switching between the DIS and the EIS, a corresponding entry/exit policy can be adopted to avoid shaking.

For ease of description, some symbols are first defined. An actual posture of a frame in the EIS is Pᵢ, a virtual state obtained after an EIS filtering is Vᵢ, and an alignment matrix that matches a video frame and a reference frame in a DIS state is Tᵢ, Tᵢ or may represent a translation matrix.

The EIS switches to a first frame of the DIS and serves as the reference frame for performing matching and alignment in a DIS processing state. A subsequent frame has a translation transformation relative to the reference frame and may be represented by the translation matrix Tᵢ. However, the translation transformation is obtained by performing matching on an original image of the video frame, and the reference frame finally output by the EIS is the virtual state. If the translation transformation Tᵢ is directly applied to the virtual state of a current frame, the video shake exists during switching. In some embodiments, an EIS actual state Pᵣ to a virtual state Vᵣ transition of the reference frame is also applied to each frame, plus the translation transformation Tᵢ of the current frame relative to the reference frame, so that a transformation of each frame in the DIS state is Pᵣ*Vᵣ⁻¹*Tᵢ.

When the EIS is switched to the DIS, a transformation before the switch is Pᵢ*Vᵢ⁻¹, and a transformation after the switch is Pᵣ*Vᵣ⁻¹*Tᵢ₊₁. Basically, there is no connection. If it is only switched, there will be an obvious shake.

In some implementations, to eliminate an impact of a virtual state and an actual state of the EIS, in a switching process, the filtering strength of the EIS is reduced. The filtering strength of the EIS is also referred to as a smoothing strength of the EIS. In some embodiments, the filtering strength of the EIS is minimized, so that the actual state and the virtual state are the same, that is, P*V⁻¹ is equal to a unit matrix. In a DIS state, only the DIS technology works, and the EIS can exist or not. Therefore, when switching from the EIS to the DIS, the filtering strength of the EIS is gradually reduced, so that the virtual state of a video frame gradually approaches the actual state. In a switched frame, the filtering strength decreases to zero. Therefore, in the switching process, the impact caused by the actual state and the virtual state of the EIS is eliminated, and only an impact of a translation matrix Tᵢ is left. In the switched frame that from the EIS to the DIS, the Tᵢ may be a unit matrix. Because the switched frame is a reference frame, the Tᵢ is smoothed without further processing.

When the DIS is switched to the EIS, a transformation before the switching is Pᵣ*Vᵣ⁻¹*Tᵢ. A transformation after the switch is Pᵢ₊₁*Vᵢ₊₁⁻¹. It can be said that there is no connection. If it is only switched, there will be an obvious shake.

In some implementations, after the DIS is switched to the EIS, the filtering strength is gradually increased. Therefore, in an entire switching process, an impact of an actual state and a virtual state of the EIS is eliminated, and only an impact of a translation matrix Tᵢ is left. However, Tᵢ is in a switched frame that from the DIS to the EIS, where an offset is relatively large, and the shake is obvious when the DIS is directly switched to a unit matrix. In some embodiments, in next subsequent N frames, the offset in the translation matrix Tᵢ is gradually attenuated until it is the unit matrix, which is applied to transformations of subsequent N frames.

In this embodiment of the present application, the motion state of the imaging device during shooting of a video is acquired, and anti-shake processing is performed on the video by using an anti-shake technology with good image stabilization performance in the motion state based on the motion state of the imaging device. In this embodiment of the present application, a combination of different anti-shake technologies is implemented by using respective advantages of different anti-shake technologies, which can adapt to a video anti-shake requirement of various shake scenarios and has broad applicability.

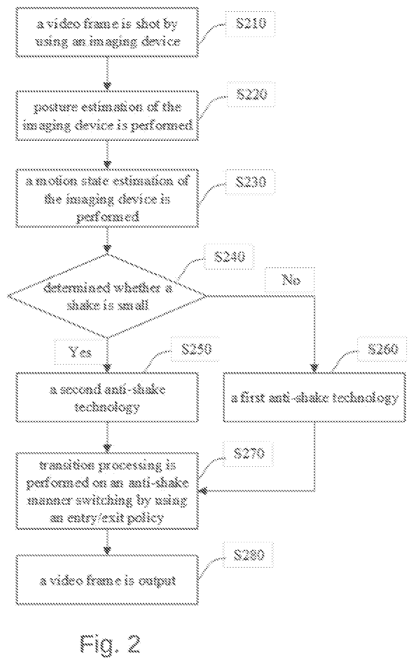

FIG. 2 is a schematic flowchart of a possible implementation manner of the method shown in FIG. 1. As shown in FIG. 2, in a process of performing state switching between the DIS and the EIS, to avoid introducing the video shake caused by state switching, a corresponding entry/exit policy is set. The method in FIG. 2 may include step S210 to step S280. The following describes these steps in detail.

In step S210, a video frame is shot by using an imaging device.

In step S220, posture estimation of the imaging device is performed. A motion of an imaging device body may be recorded by using a gyroscope built in an inertial measurement unit, that is, represents a motion of a lens. For example, an EIS anti-shake solution is performed by using a Gyro-Sensor, and a posture Euler angle of a camera may be obtained by using an attitude algorithm method, that is, represents a motion posture of a lens.

In step S230, a motion state estimation of the imaging device is performed.

In some implementations, data of the gyroscope and data of an OIS gimbal are aligned in a time and a direction, and a posture angle of the lens is obtained by means of angle calculation, so as to determine the motion state of the lens. The estimation of the motion state is described in detail below.

In step S240, determines whether the shake is small. If the imaging device is in a small shake state, step S250 is performed. If the imaging device is not in the small shake state, step S260 is performed.

In step S250, the imaging device is in the small shake state, that is, the second motion state, and performs anti-shake processing on the video frame by using the second anti-shake technology, for example, may perform anti-shake processing on the video frame by using the digital anti-shake technology. Go to step S260.

In step S260, the imaging device is not in the small shake state, that is, in the first motion state, anti-shake processing is performed on the video frame by using the first anti-shake technology, for example, anti-shake processing may be performed on the video frame by using the electronic anti-shake technology. Go to step S270.

In step S270, transition processing is performed on the anti-shake manner switching by using an entry/exit policy.

In some implementations, if an EIS state is switched to a DIS state, a filtering strength of the EIS is gradually reduced, so that the virtual state of the video frame gradually approaches the actual state. If the DIS state is switched to the EIS state, the offset in the translation matrix Tᵢ is gradually attenuated until it is a unit matrix.

In step S280, anti-shake processing of the video frame is completed, and the video frame is output.

In this embodiment of the present application, the motion state of the imaging device during shooting of a video is acquired, and anti-shake processing is performed on the video according to the motion state in which the imaging device is located by using an anti-shake technology with good image stabilization performance that matches the motion state. In a process of switching the anti-shake technology, an entry/exit policy is used for transition processing, thereby avoiding the video shake caused by switching the anti-shake manner. This embodiment of the present application implements integration of different anti-shake technologies, uses respective advantages of multiple anti-shake technologies in different shake scenarios, and can be applicable to a scenario in which a single anti-shake technology is used, or can be applicable to a scenario in which multiple anti-shake technologies are used in combination, which has broad applicability.

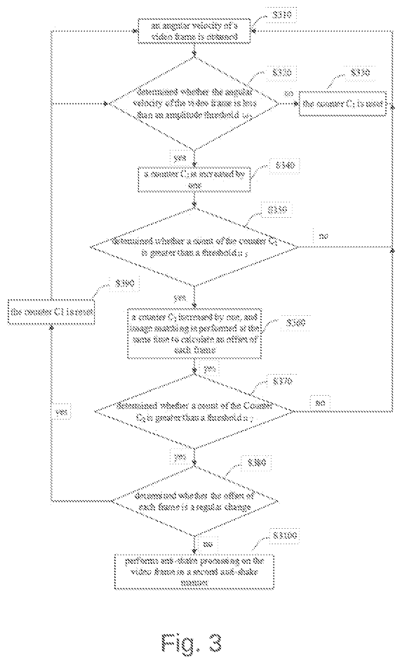

FIG. 3 is a schematic flowchart of a possible implementation manner of the S230-S240 step of the method shown in FIG. 2. In the method shown in FIG. 3, a motion state of the imaging device is mainly determined based on factors such as a shaking amplitude, a shaking duration, and a shaking rule.

As shown in FIG. 3, for each video frame, first, an angular velocity of the video frame is determined, that is, the change of a posture angle of the frame relative to that of the previous frame. If the angular velocity is less than a set amplitude threshold ω₁, it may be considered that the frame is in a relatively small amplitude motion state, and a counter C₁ increases by one. Otherwise, it is considered that a motion state amplitude of the frame is relatively large, and the counter C₁ is cleared. Until the counter C₁ accumulates to a value greater than a specified threshold μ₁, and the threshold μ₁ is a first time threshold, the imaging device may be considered that (the imaging device) is currently in a state of continuous small-amplitude motion. In this case, the counter C₁ stopped increasing and a counter C₂ began to increase. At the same time, image content matching is performed on each frame, and an offset of each frame relative to a reference frame is calculated. The reference frame is generally the first frame that starts to match. When the counter C₂ is greater than a threshold μ₂, the threshold μ₂ is a second time threshold, and it is determined whether the offset of each frame is a regular change. This step is to distinguish between slow movement of a small amplitude and irregular shake of a small amplitude. A state of small-amplitude irregular shake is the second motion state, and a DIS anti-shake manner is used only in the second motion state of small-amplitude irregular shake.

The method in FIG. 3 mainly includes step S310 to step S380. The following describes these steps in detail.

In step S310, the angular velocity of the video frame is obtained. In some embodiments, a posture angle of a lens is obtained by means of angle calculation based on alignment between data of a gyroscope and data of an OIS gimbal in a time and a direction, that is, a posture angle of a video frame is obtained. The angular velocity of the video frame may be obtained based on a change of the posture angle of the video frame relative to the posture angle of the previous frame.

In step S320, it is determined whether the angular velocity of the video frame is less than the amplitude threshold ω₁. If the angular velocity is less than the amplitude threshold ω₁, step S340 is performed. Otherwise, go to step S330.

In step S330, it is considered that a motion state of the frame is of a relatively large amplitude, and the counter C₁ is reset, and step S310 is returned.

In step S340, the counter C₁ is increased by one.

At step S350, it is determined whether a count of the counter C₁ is greater than the threshold μ₁. If the count of the counter C₁ is greater than the first-time threshold μ₁, step S360 is performed. Otherwise, it is considered that the shake of the frame lasts for a relatively short time, and step S30 is returned to continue determining an angular velocity of a next frame.

In step S360, the count of the counter C₁ is greater than the first-time threshold μ₁, may be considered as being in a state of continuous small-amplitude motion. In this case, the C₁ stopped increasing and the counter C₂ began to increase.

The counter C₂ is increased by one, and image matching is performed at the same time to calculate the offset of each frame. The offset of each frame is the offset relative to the reference frame, and the reference frame is usually the first frame that starts to match.

In step S370, it is determined whether a count of the counter C₂ is greater than the threshold μ₂. If (it) is greater than the second time threshold μ₂, step S380 is performed. Otherwise, go to step S310.

In step S380, it is determined whether the offset of each frame is the regular change. This step is to distinguish small amplitude slow movement and small amplitude irregular shake. If each frame offset is the regular change, step S390 is performed. Otherwise, go to step S3100.

In step S390, the offset of each frame is the regular change, and the counter C₁ is reset. Go to step S310.

In step S3100, the imaging device is in the second motion state of small amplitude irregular shake and performs anti-shake processing on the video frame in the second anti-shake manner, such as the digital anti-shake technology.

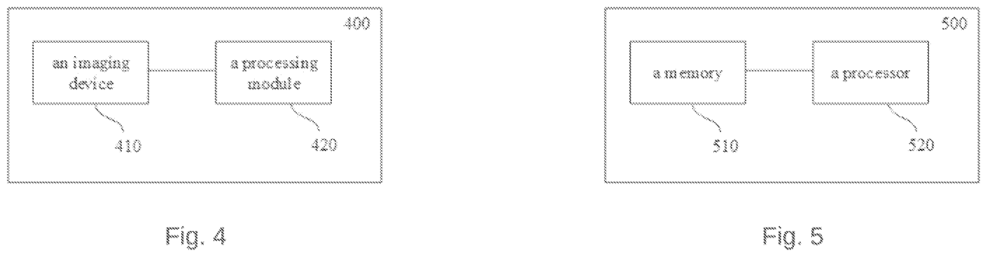

The foregoing describes the method embodiments of the present application in detail with reference to FIG. 1 to FIG. 3. The following describes apparatus embodiments of the present application in detail with reference to FIG. 4. It should be understood that the description of the apparatus embodiment corresponds to the description of the method embodiment. Therefore, for a part that is not described in detail, reference may be made to the foregoing method embodiments.

FIG. 4 is a schematic structural diagram of a video shooting apparatus according to an embodiment of the present application. As shown in FIG. 4, the video shooting apparatus 400 may include an imaging device 410 and a processing module 420.

The imaging device 410 is configured to shoot a video, and may be various digital cameras, cameras, shooting apparatuses in a smartphone, or the like.

The processing module 420 is connected to the imaging device 410, and is configured to perform the following operations: acquiring a motion state of the imaging device 410 during shooting of a video; performing anti-shake processing on the video in a first anti-shake manner that matches a first motion state when the image device 410 is in the first motion state; performing anti-shake processing on the video in a second anti-shake manner that matches a second motion state when the image device 410 is in the second motion state; wherein a shaking amplitude in first motion state is different from a shaking amplitude in the second motion state.

Optionally, the motion state of a lens may be determined by acquiring first motion data and second motion data of the imaging device. Wherein the first motion data is motion data collected by a sensor used in an electronic anti-shake manner, for example, data of a gyroscope and an acceleration sensor in IMU, which represents a motion state of a body. The second motion data is motion data used when a gimbal performs motion compensation on the imaging device. Actual motion data of the lens of the imaging device, such as a posture angle or a motion posture of the lens, may be determined based on the first motion data of the body and the second motion data compensated by the gimbal. Based on the actual motion data or the motion posture of the lens of the imaging device, a motion state of the lens during shooting of a video may be acquired.

Optionally, if the imaging device switches from the first motion state to the second motion state, before the first anti-shake manner is switched to the second anti-shake manner, a difference between a video frame obtained based on the processing performed in the first anti-shake manner and an original video frame is gradually reduced, so as to reduce a video shake caused by switching from the first anti-shake manner to the second anti-shake manner. Similarly, if the imaging device switches from the second motion state to the first motion state, before switching from the second anti-shake manner to the first anti-shake manner, a difference between a video frame obtained based on the processing performed in the second anti-shake manner and an original video frame is gradually reduced, so as to reduce a video shake caused by switching in the anti-shake manner.

Optionally, before the first anti-shake manner is switched to the second anti-shake manner, the difference between the video frame and the original video frame obtained based on the processing performed in the first anti-shake manner is gradually reduced. The video may include a reference frame, where the reference frame is the first video frame obtained after the first anti-shake manner is switched to the second anti-shake manner, and the reference frame is the original video frame that has not been processed in the first anti-shake manner Performing, in the second anti-shake manner, anti-shake processing on the reference frame and a subsequent video frame, so as to reduce the video shake caused when the first anti-shake manner is switched to the second anti-shake manner.

Optionally, the first anti-shake manner is the electronic anti-shake manner, the second anti-shake manner is a digital anti-shake manner, and a shaking amplitude in the first motion state is greater than a shaking amplitude in the second motion state.

Optionally, before the electronic anti-shake manner is switched to the digital anti-shake manner, a shaking rule of the imaging device is determined. If the imaging device performs irregular shake, switching an anti-shake manner of the imaging device from the electronic anti-shake manner to the digital anti-shake manner. If the imaging device performs a regular shake, continue to perform anti-shake processing on the video in the electronic anti-shake manner.

In this embodiment of the present application, the motion state of the imaging device during shooting of a video is acquired, anti-shake processing is performed on the video by using an anti-shake technology with good image stabilization performance in the motion state based on the motion state of the imaging device, and in a process of switching the anti-shake technology, an entry/exit policy is used to perform transition processing, thereby avoiding the video shake caused by switching in an anti-shake manner. This embodiment of the present application implements integration of different anti-shake technologies and is applicable to a scenario in which a single anti-shake technology is used, and to a scenario in which multiple anti-shake technologies are used together, which has broad applicability.

FIG. 5 is a schematic structural diagram of an electronic device according to an embodiment of the present application. As shown in FIG. 5, the electronic device 500 may include a memory 510 and a processor 520.

The memory 510 is configured to store a computer program.

The processor 520 is connected to the memory 510 and is configured to execute the computer program stored in the memory 510 to implement the method described in any one of the foregoing.

It should be noted that the electronic device mentioned in this embodiment of the present application is an electronic device that includes microelectronic components and has a shooting function and refers to a device that may include electronic components such as an integrated circuit, a transistor, and an electronic transistor and that is used to function by using an electronic technology (including software). The electronic device may be a random device, and the electronic device may be referred to as a terminal, a portable terminal, a mobile terminal, a communications terminal, a portable communications terminal, a portable mobile terminal, a touchscreen, or the like. For example, the electronic device may be but is not limited to various smartphones, digital cameras, cameras, laptops, tablets, smartphones, portable phones, game consoles, television, display units, personal media player (personal media player, PMP), personal digital assistant (personal digital assistant, PDA), and robots controlled by electronic computers. The electronic device may also be a portable communications terminal that has a wireless communication function and a pocket size.

An embodiment of the present application further provides a computer readable storage medium, and a computer program is stored on the computer readable storage medium. The computer program is used to implement the method described in any one of the foregoing descriptions.

It should be understood that the computer readable storage medium mentioned in this embodiment of the present application may be any usable medium readable by a computer, or a data storage device, such as a server or a data center, integrating one or more usable media. The usable medium may be a magnetic medium (for example, a floppy disk, a hard disk, or a magnetic tape), an optical medium (for example, a digital versatile disc (digital video disc, DVD)), a semiconductor medium (for example, a solid-state drive (solid state disk, SSD)), or the like.

It should be understood that, in various embodiments of the present application, “first”, “second”, and the like are used to distinguish different objects, rather than to describe a specific order. Sequence numbers of the foregoing processes do not mean execution sequences. The execution sequences of the processes should be determined according to functions and internal logic of the processes and should not be construed as any limitation on the implementation processes of the embodiments of the present application.

In the several embodiments provided in the present application, it should be understood that the disclosed system, apparatus, and method may be implemented in other manners. For example, the described apparatus embodiment is merely an example. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatus or units may be implemented in electronic, mechanical, or other forms.

In the several embodiments provided in the present application, it should be understood that when a part is referred to as being “connected” or “connected” to another part, it means that the part may not only be “directly connected”, but also “electrically connected”, and another component intervenes. In addition, the term “connection” also means “physical connection” and “wireless connection” of the portion. In addition, when a portion is referred to as “include” an element, it means that the portion may include another element, not exclude another element, unless otherwise stated.

The units described as separate parts may or may not be physically separate, and parts displayed as units may or may not be physical units, may be located in one place, or may be distributed on multiple network units. Some or all of the units may be selected according to an actual requirement to implement the objectives of the solutions in this embodiment.

In addition, functional units in the embodiments of the present application may be integrated into one processing unit, or each unit may exist separately physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

While illustrative implementations of the application have been described in detail herein, it is to be understood that the inventive concepts may be otherwise variously embodied and employed, and that the appended claims are intended to be construed to include such variations, except as limited by the prior art.

Modules mentioned above may be fully or partially implemented by software, hardware and a combination thereof. The above-mentioned modules may be embedded in or independent of the processor in the computer device in the form of hardware and may also be stored in the memory of the computer device in the form of software, so that the processor can invoke and execute the corresponding operations of the above-mentioned modules.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

What is claimed is:

1. A video shooting method, comprising:
acquiring a motion state of an imaging device during shooting of a video;
when the imaging device is in a first motion state, performing anti-shake processing on the video in a first anti-shake manner that matches the first motion state;
when the imaging device is in a second motion state, performing anti-shake processing on the video in a second anti-shake manner that matches the second motion state; and
wherein a shaking amplitude in the first motion state is different from a shaking amplitude in the second motion state.

2. The method according to claim 1, wherein the method further comprises:
before the first anti-shake manner is switched to the second anti-shake manner, gradually reducing a difference between a video frame obtained based on the processing performed in the first anti-shake manner and an original video frame, to reduce a video shake caused by switching from the first anti-shake manner to the second anti-shake manner.

3. The method according to claim 2, wherein the video comprises a reference frame, the reference frame is the first video frame obtained after the first anti-shake manner is switched to the second anti-shake manner, and the reference frame is the original video frame that has not been processed in the first anti-shake manner.

4. The method according to claim 1, wherein the first anti-shake manner is an electronic anti-shake manner, the second anti-shake manner is a digital anti-shake manner, and the shaking amplitude in the first motion state is greater than the shaking amplitude in the second motion state.

5. The method according to claim 4, wherein the acquiring a motion state of an imaging device during shooting of a video comprises:
acquiring a first motion data and a second motion data of the imaging device, wherein the first motion data is motion data collected by a sensor used in the electronic anti-shake manner, and the second motion data is motion data used when a gimbal performs motion compensation on the imaging device;
determining actual motion data of the imaging device based on the first motion data and the second motion data; and
acquiring, based on the actual motion data of the imaging device, the motion state of an imaging device during shoot of a video.

6. The method according to claim 4, wherein the method further comprises:
before the electronic anti-shake manner is switched to the digital anti-shake manner, determining a shaking rule of the imaging device; and
if the imaging device performs an irregular shake, switching an anti-shake manner of the imaging device from the electronic anti-shake manner to the digital anti-shake manner; or
if the imaging device performs a regular shake, continuing to perform anti-shake processing on the video in the electronic anti-shake manner.

7. A video shooting apparatus, comprising:
an imaging device, configured to shoot a video; and
a processing module, connected to the imaging device, and configured to perform the following operations:
acquiring a motion state of the imaging device during shooting of the video;
when the imaging device is in a first motion state, performing anti-shake processing on the video in a first anti-shake manner that matches the first motion state;
when the imaging device is in a second motion state, performing anti-shake processing on the video in a second anti-shake manner that matches the second motion state; and
wherein a shaking amplitude in the first motion state is different from a shaking amplitude in the second motion state.

8. The apparatus according to claim 7, wherein the processing module is further configured to perform the following operations:
before the first anti-shake manner is switched to the second anti-shake manner, gradually reducing a difference between a video frame obtained based on the processing performed in the first anti-shake manner and an original video frame, so as to reduce a video shake caused by switching from the first anti-shake manner to the second anti-shake manner.

9. The apparatus according to claim 8, wherein the video comprises a reference frame, the reference frame is the first video frame obtained after the first anti-shake manner is switched to the second anti-shake manner, and the reference frame is the original video frame that has not been processed in the first anti-shake manner.

10. The apparatus according to claim 7, wherein the first anti-shake manner is an electronic anti-shake manner, the second anti-shake manner is a digital anti-shake manner, and a shaking amplitude in the first motion state is greater than a shaking amplitude in the second motion state.

11. The apparatus according to claim 10, wherein the acquiring a motion state of the imaging device during shooting of the video comprises:
acquiring first motion data and second motion data of the imaging device, wherein the first motion data is motion data collected by a sensor used in the electronic anti-shake manner, and the second motion data is motion data used when a gimbal performs motion compensation on the imaging device;
determining an actual motion data of the imaging device based on the first motion data and the second motion data; and
acquiring, based on the actual motion data of the imaging device, the motion state of the imaging device during shooting of the video.

12. The apparatus according to claim 10, wherein the processing module is further configured to perform the following operations:
before the electronic anti-shake manner is switched to the digital anti-shake manner, determining a shaking rule of the imaging device; and
if the imaging device performs an irregular shake, switching an anti-shake manner of the imaging device from the electronic anti-shake manner to the digital anti-shake manner; or
if the imaging device performs a regular shake, continuing to perform anti-shake processing on the video in the electronic anti-shake manner.

13. An electronic device, comprising:
a memory, configured to store a computer program; and
a processor, connected to the memory and configured to implement the method according to claim 1 when the computer program is executed.

14. A non-transitory computer readable storage medium on which a computer program is stored, wherein when executed by a processor, the computer program implements the method according to claim 1.
